(19) United States
(12) Patent Application Publication
(10) Pub. No.: US 2012/0290394 A1
(43) Pub. Date: Nov. 15, 2012

(54) SYSTEM AND METHOD FOR DISPLAYING DIGITAL CONTENT

(75) Inventors: Karen Shapiro, New York, NY (US); Francesco Dori, Lastra A Signa (IT)

(73) Assignee: Karen Shapiro, New York, NY (US)

(21) Appl. No.: 13/537,719

(22) Filed: Jun. 29, 2012

Related U.S. Application Data
(63) Continuation-in-part of application No. PCT/IB2010/056137, filed on Dec. 30, 2010.
(60) Provisional application No. 61/335,111, filed on Jan. 2, 2010.
(60) Provisional application No. 61/399,436, filed on Jul. 12, 2010.

(51) Int. Cl. G06Q 30/02

(52) U.S. Cl. 705/14.58

(57) ABSTRACT

The present invention is of system for publishing digital content. The system includes a device for displaying digital content and a remote server that is in communication with the device. The remote server is configured for determining a geo-location of the device; and communicating digital data to the device according to a parameter relating to individuals being in proximity to a user operating the device.

### CROSS REFERENCE TO RELATED APPLICATIONS

This Application is a Continuation-in-part of Application PCT/IB2010/056137 filed on Dec. 30, 2010. Application PCT/IB010/056137 claims the benefit of U.S. Provisional Application 61/335,111 filed on Jan. 2, 2010. Application PCT/IB2010/056137 claims the benefit of U.S. Provisional Application 61/399,436 filed on Jul. 12, 2010. All applications hereby expressly incorporated in their entireties for all purposes by reference thereto.

### BACKGROUND OF THE INVENTION

The present invention relates to a system and method for displaying digital content and, more particularly, but not exclusively, to systems which are configured for displaying crowd-targeted digital content loaded from a local storage device or server in accordance with the geo-location of the system or a user thereof.

In the digital age older methods of advertising, such as newspaper and radio, are being replaced with digital advertising communicated to individuals via computers and mobile devices as well as digital billboards.

At present, digital billboard advertising is the fastest growing medium after the Internet. The billboard, which started with static hand painted boards, evolved into LED billboards capable of displaying dynamic multi-media content. As an emerging media system, LED video billboards offer greater flexibility than conventional billboards, and as such, High Resolution LED billboards are replacing the conventional billboard as the crowd display system of choice.

Digital displays provide several advantages over static billboards including dynamic content and interactivity, guaranteed delivery and scheduled display, multiple advertisers with no clutter, co-op revenue opportunities, instant digital changes for season, price, or promotion, rapid ability to update content, and the ability to deliver specific messages to specific audiences in specific locations.

Although such billboards are effective in providing audience-targeted advertisements, they are limited by their deployment requirements (space and power) and thus they cannot be used in areas that do not support such requirements. In addition, since digital billboards are typically large, they are positioned at a distance from the target viewers and as such, are often less effective in delivering crowd-targeted content.

Thus, there remains a need for a system that enables publishing of digital content to a crowd while being devoid of the limitations associated with conventional digital billboards.

### BRIEF SUMMARY OF THE INVENTION

The present invention is a system for publishing digital content. A representative system includes (a) a device for displaying digital content and (b) a remote server that is in communication with the device. The remote server is configured for (i) determining a geo-location of the device; and (ii) communicating digital data to the device, wherein a type and/or a content of the digital data is determined according to a parameter relating to individuals being in proximity to a user operating the device.

According to preferred embodiments of the present invention the functionality of the present device is provided by one or more interconnected units. For example, the computational and communication as well as geo-location features can be provided by a single device connected to an external display.

The device can be carried by a user, in which case the display is preferably worn on a chest or back of the user (integrated into clothing, an accessory such a backpack, purse, tote, or the like, or hung via, for example, a lanyard). The device can also be mounted on a vehicle in which case the display is preferably mounted on a roof or side panel.

The present invention successfully addresses the shortcomings of the presently known configurations by providing a system and method for publishing digital content, often dynamic digital content, to targeted audiences. That digital content may include conventional visual/audio content in addition to or in lieu of unidimensional or multidimensional barcodes (e.g., a quick response code (QR code) or other scannable tag in which a user in proximity of the digital content initiates an interaction event with the digital content, including in the case of a QR code, scanning the QR code for ease in accessing or consuming the information). Such an arrangement further enables another feature of the present invention in which revenue or compensation may be cooperative and shared among contributors responsible for presenting a particular unit of scanned digital content to a prospective or actual consumer. Various methods of attribution and revenue sharing are possible, such as based upon scanning, based upon consumer inquiry using information from the scanned digital content, redemption of the scanned digital content, a combination, or other suitable metric.

For locally stored and presented content, adding contributor attribution to digital content shared from one contributor to another enables multi-level marketing compensation programs in which multiple contributors may accrue a benefit/compensation from appropriate uses of the accessed digital content.

For remote/server based (and wirelessly distributed content), some embodiments provide for use of performance and other information (e.g., demographic, geo-location, and the like) in establishing a dynamic market for access to particular contributors/locations. That dynamic market may be accessed, such as for example, using auction-based models. In other cases, a model includes payment from a content provider not based upon screens or cost per mille in presenting digital content, but payment models based upon consumption/access of the digital content.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions, stored in a memory or other non-transitory medium.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a digital presentation system in which a portable electronic device is carried by a user;

FIG. 2 illustrates a digital presentation system a portable electronic device is mounted on a mobile platform (e.g., a vehicle); and

FIG. 3 illustrates an interface of a portable electronic device used in a digital presentation system described herein.

### DETAILED DESCRIPTION OF THE INVENTION

The present invention is a system that can be used to publish digital content to a targeted group of individuals. Specifically, the present invention can be used to target digital content to specific groups of individuals, by using geo-located individuals as walking billboards.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Although digital billboards are considered effective in distributing digital content to targeted audiences, attempts have been made to enhance digital distribution by using individuals as walking digital billboards.

The “walking TV” (www.electronics.howstuffworks.com/gadgets/other-gadgets/fabric-display6.htm) was devised in efforts to overcome some of the limitations of static advertisements, however, since this approach relied on individuals wearing displays preloaded with digital content it was event targeted and thus could not be used for ad-hoc advertising.

While reducing the present invention to practice, the present inventors have devised a digital content publishing system, which provides ad-hoc audience-targeted digital content and yet is devoid of the limitations of prior art digital content publishing systems.

Thus, according to one aspect of the present invention there is provided a system for publishing digital content. As used herein, the phrase “digital content” refers to any textual, image, audio, or video content generated from digital data.

The present system includes a device configured for displaying digital content and a remote server that is capable of communicating with the device.

The device typically includes a display (e.g. LED, OLED or e-ink), a processor and wireless capabilities (e.g. WiFi, WiMax, Cellular, satellite) housed in one or more units. The device can also include a GPS unit (e.g. a GPS). Although the device or its display can be mounted on a stationary object (e.g. building, landmark etc.), mounting the device on a moving object (e.g. car) or having it carried/worn by an individual provides advantages especially in cases where the displayed content includes an advertising message.

Thus, as is further described hereinbelow, the present device or its display is preferably configured to be carried/worn by a user (e.g. human subject) using, for example, a lanyard, such that the display is positioned on the user's chest or back, or to be mounted on a vehicle (e.g. car, truck, boat, motorcycle, bicycle etc.) using mounting hardware, or having the device carried by users.

The remote server is configured for determining a geo-location of the device; and for communicating digital data to the device, whereas the type and/or a content of the digital data is determined according to a parameter relating to individuals that are in proximity to a user carrying the device or to the vehicle on which the device is mounted.

Embodiments of the present system which includes the device and remote server are further described hereinbelow with reference to the figures.

As used herein, the term “geo-location” refers to the physical location of the user/vehicle as determined via GPS, cellular or Wi-Fi tracking (further describe below); the number of individuals being in proximity to the user or vehicle is a function of such geo-location data and is one example of a parameter that can be related to such individuals.

Once a location of the device is known, one can estimate the number of people that are in proximity to the device according to, for example, the day of the week, the time of day, season etc. For example, if the device is worn or carried by a user who is located on a college campus during a school day at 12:00 noon, one can estimate the number of individuals that are present in the general location of the user and thus, one can also estimate the number of individuals that are likely to be in the immediate vicinity of the user over the course of, for example, an hour. Geo-location data can also be used to estimate additional parameters such as average age of the individuals in the vicinity of the user and a gender of such individuals, since in many cases the age and gender of such individuals can be correlated to their location (e.g. college campus,).

Parameters associated with individuals being in proximity to the device can also include activity of the individuals (location thereof indicates exercising, watching a sporting event etc.) as well as needs (new Nike football shoes) and interests (future football match events).

In any case, once a geo-location of the device is determined by the remote server, digital data is communicated from the remote server to the device using a cellular network or the internet. Such data is then displayed on the display of the device as digital content that can include text, images and/or video, as well as audio. Such content is preferably targeted to the individuals being in proximity to the device and can include advertising information.

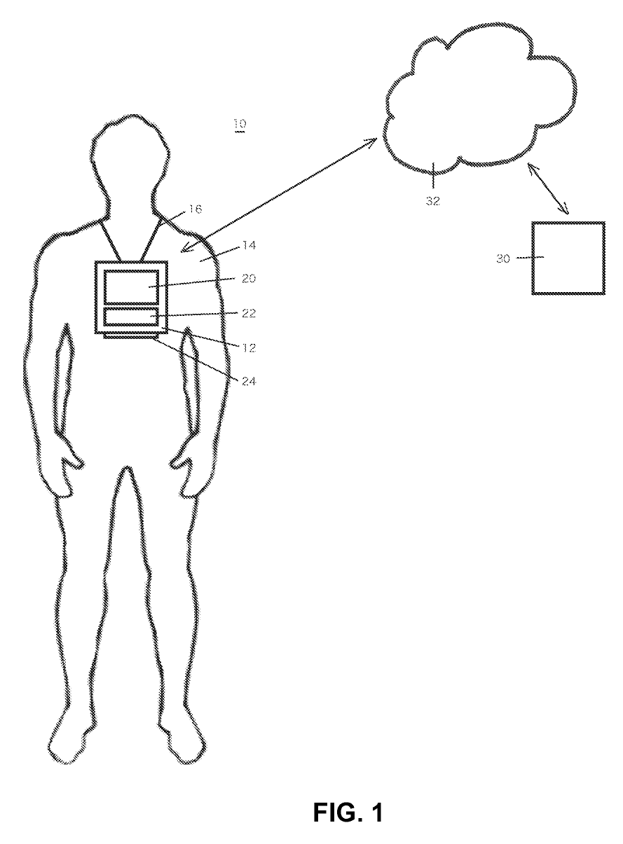

FIG. 1 illustrates the present system that is referred to as system 10. System 10 includes device 12 shown mounted on a user 14 via lanyard 16. Other methods of mounting include clips, Velcro strips, belts, magnets and the like.

Device 12 includes a display 20 which can be an LED, LCD, OLED, e-ink or any other display capable of displaying digital content. OLED and e-ink displays are preferred due to their low power consumption. Display 20 is positioned on user 14 such that it faces away from the body of the user and thus can be seen by individuals in the vicinity of the user.

Device 12 further houses a CPU (e.g. an ARM processor), a power source (e.g. a rechargeable Li ion battery), a communication module which includes wireless capabilities (e.g. cellular, Wi-Fi, Bluetooth) and optionally a GPS unit for providing GPS data to the server as is further described below.

Device 12 further includes a user interface 22 (including a real or virtual keyboard) for operating device 12 and communication ports 24 for connecting device 12 to a computer for charging and data transfer as is further described below.

Display 20 can be a round, rectangular, square, triangular, globe or cube shaped display having one or more display surfaces. Display 20 can have a housing fabricated from plastic, rubber, metal or a combination thereof using fabrication methods well known in the art of display design.

Device 12 can also include speakers for providing audio data and a microphone for inputting audio data. Device 12 can run any operating system suitable for personal mobile devices including mobile variants of Linux, Mac OS™, Windows™ and the like.

The functionality of device 12 can be implemented through a single device that includes the above mentioned components within a single device body 18, or alternatively, device 12 can be realized via a mobile device such as a smart phone (e.g. iPhone). In the latter case, the mobile phone can be fitted with the appropriate software for the functionality described herein.

Still alternatively, device 12 can be realized by connecting a wearable display to a mobile device. In this configuration a wearable OLED or e-ink display can be connected (via wires or wireless through, for example, Blue Tooth) to a mobile device having communication and processing capabilities (e.g. cellular telephone). Display functions would be handled by the display, whereas communication and processing functions, as well as user input and the like would be handled by the connected mobile device.

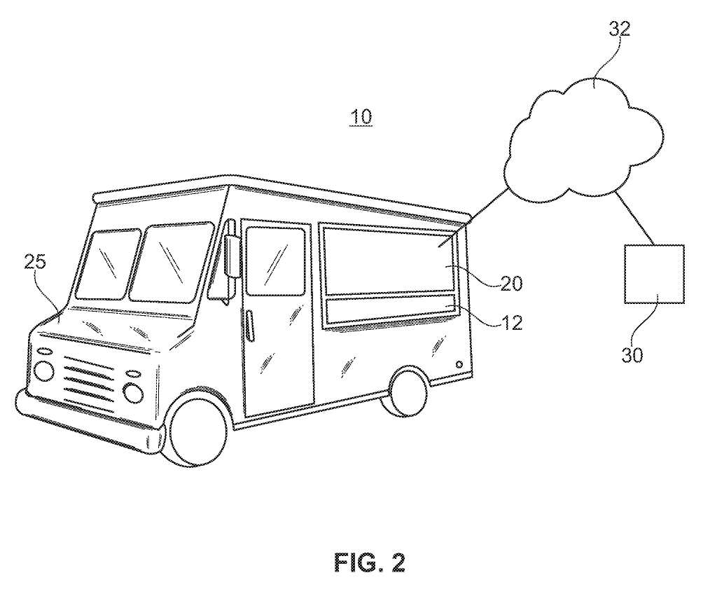

FIG. 2 illustrates a second configuration of system 10 in which device 12 or portions thereof (e.g. display 20) is mounted on a side panel of a truck using mounting hardware (e.g. bolts or magnets). Device 12 or display 20 can be mounted on any region of a vehicle 25. Preferred are highly visible regions such as doors, windows, side panels and the like; roof mounting of device 12 or display 20 can be effected using a roof rack. Examples of vehicles include delivery and ice cream trucks, busses, commuter cars, taxis, trains, and the like.

The functionality of a vehicle-mounted device 12 can be implemented through a single device that includes the above mentioned components within a single device body, or alternatively, device 12 can be realized by using the vehicles on board system to provide the communication and geo-location functionalities (as well as user interface), while a separate display can be mounted on the roof (as shown) and connected to the vehicles on-board system. The vehicle on-board system can be fitted/modified with the appropriate software for the functionality described herein.

System 10 further includes remote server 30 that is capable of communicating with device 12 through a communication network 32.

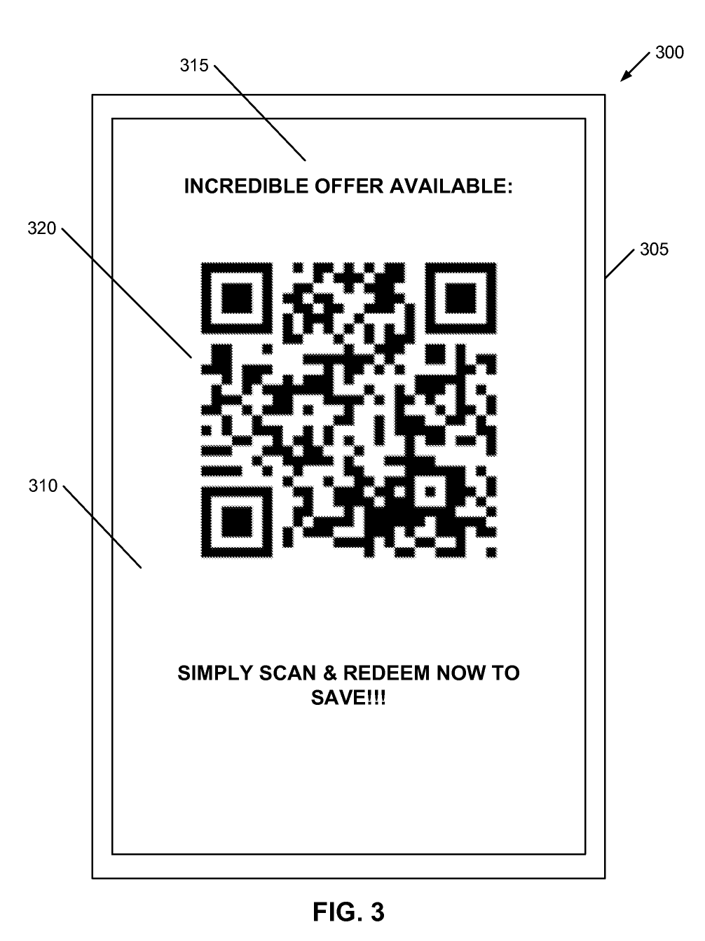

FIG. 3 illustrates a presentation system using a portable electronic device 305 (e.g., device 12) supporting an interface 310. Portable electronic device 305 may be a special purpose system specifically configured for presentation of the digital content, or a general purpose device including an application or other computing process to selectively render and communicate the digital content in the appropriate format. The renderer for purely visual digital content may be a display, for still or motion content, it includes electronic transducers for audibilizing audio digital content, and a combination for “multimedia” digital content including visual and audio elements. Portable electronic device 305 includes a processor and a memory for storing program instructions, and an I/O (input/output) system for controlling operation, rendering the digital content, storing, managing, and receiving collections of individual digital content elements, tabulating and managing contributor and consumer interactions with the digital content, and any local and/or remote communications system, all operable from battery power.

Interface 310, in this case a display, renders the digital content which includes a human-readable portion 315 and a machine-readable portion 320. Human readable portion includes content to explain, entice, or otherwise encourage a prospective consumer to access machine-readable portion 320. Machine-readable portion 320 includes a tag, indicia, QR code (as shown) or other data structure enabling access, monitoring, attribution, tracking, and consumption of the digital content (and implicitly some offer, incentive, or other value represented by the digital content). As processing power increases for portable electronic devices, in some implementations there may be no distinction between human-readable portion 315 and machine-readable portion 320 as a consumer's portable electronic device will be able to directly use human-readable portion 315.

In operation, a contributor ports portable electronic device 305 and presents interface 310 (either passively such as being worn or attached to outer garments or a carried accessory (e.g., backpack) or actively by holding the display out for inspection and directing specific attention to the digital content) to a collection of persons in the user's vicinity. Some or all of the consumers will be able to perceive and access the digital content. A prospective consumer, motivated by the contributor and/or human-readable portion 315, accesses and records machine-readable portion 320, such as by operation of their own portable electronic including an appropriate feature. This appropriate feature includes a QR code scanner, such as operable on the consumer's portable electronic device (e.g., tablet computer, smartphone, PDA, or similar portable processor-powered device).

In the present context, machine-readable contemplates machine-cognizable with a scanning/reading device accessing the machine-readable portion which initiates a predetermined function determined by the digital content. In this sense, simple imaging of the digital content (e.g., taking a photograph of it) is not within the present definition of machine readable which includes an element of parsing and initiating active functions of the consuming device (e.g., opening a web browser window to a particular URL (uniform resource locator) identified by the digital content). This greatly facilitates the use of long URLs, such are often used for tracking which become a challenge for users to manually enter. Tracking is an important element of preferred embodiments of the present invention as it helps incentivize contributors to port and present the digital content to individuals in their proximity. The widespread presentation of digital content in this fashion incentivizes digital content providers to pay for the distribution, which then makes it valuable to consumers. As consumers make wider use of the digital content made easily and simply available to them, the more incentive exists for the contributors, mutually supporting each other.

In some implementations, the digital content is dynamic in the sense that it changes based upon the conditions specified. The digital content may change based upon location, parameter of the prospective consumers, and/or lapse time. Some implementations provide that the rendered digital content change periodically (e.g., every 15 seconds). Interface 310 preferably includes an ability to “backup” to retrieve a previously rendered digital content element and make it available for scanning.

Mobile advertising is a new concept. Competition for the entire nascent industry comes from established media including on line, social, print, broadcast, direct mail and the like. Conventional media cannot match offerings of the disclosed systems, price, flexibility and ability to target. Search engines are web-centric, do not provide the local reach, immediacy and flexibility that the present invention can offer its advertisers. Local deal sites require merchants to provide steep discounts and shoppers to pay for their deal. Digital content in the context of the disclosed systems offers instant deals at no cost to the shopper, providing a low risk pay-for-performance advertising model that is a very effective, efficient advertising option for large and small advertisers.

There are many mechanisms by which the machine-readable portion may be accessed, tracked, and monitored, the specifics of which are not central to the manufacture and use of the present invention. While these functions exist, they are adapted and customized for the particular implementation.

As used herein, the term “server” refers to a computing platform (e.g. personal computer, workstation or mainframe) that is capable of receiving and sending data via one or more communication network types and is configured for storing and processing data.

As used herein, the phrase “communication network” refers to any communication network, including, but not limited to, the Internet, Cellular telephone networks, satellite networks and the like.

As is mentioned hereinabove, remote server 30 is configured with software capable of determining a geo-location of the device. In that respect, remote server 30 periodically queries device 12 for location data, or alternatively device 30 periodically sends location data to remote server 30. Such location data can be derived from cellular tower data (www.en.wikipedia.org/wiki/Mobile_phone_tracking), proximity of device 12 to Wi-Fi base stations (e.g. the PlaceLab Geo-positioning system—www.ntrg.cs.tcd.ie/undergrad/4ba2.05/groupl/index.html) or from a GPS unit of device 12. In any case, such location data is utilized by remote server 30 to identify the physical location of user 14 (wearing device 12) or of vehicle 25 (on which device 12 is mounted) and to estimate a size of a crowd in vicinity to device 12 (e.g. in the vicinity of user 14 or vehicle 25).

Such estimation can rely on a number of variables processed by remote server 30. Such variables can include the date, day of the week and time of day, proximity of user 14 or vehicle 25 to a public structure/area, building or landmark, foot as well as car/public transport traffic in the area, as well as office complexes, retail establishments (shops, spas, hair salons, restaurants, etc.).

These variables are used by remote server 30 to estimate the size, average age, gender and possibly interests of individuals being in proximity to user 14 or vehicle 25.

Once such a crowd is defined by remote server 30, it communicates to device 12 digital data which includes content that is targeted to such individuals. For example, if remote server 30 detects that user 14 or vehicle 25 and hence device 12 are located in or near (e.g. parking lot) a sports stadium and its midday Sunday, it estimates that the crowd surrounding user 14 or vehicle 25 are sports fans and thus communicates to device 12 a beer advertisement. On a Saturday afternoon in Oxford street server 30 determines that user 14 and device 12 are in the proximity of the Nike shop. It could advertise the sale at Puma of similar products on sale at Nike. It will be appreciated that in the case of a vehicle-mounted system, an operator of the vehicle need not be in it for system 10 to be operational. In the example of a sports stadium, system 10 can be configured to display advertisement prior to and following a sports event even if the car is parked and not operated.

If on the other hand, remote server 30 determines that device 12 is in an area that likely includes very few people (user at home, car parked at home), no digital data is communicated to device 12.

Aside from managing the content displayed on device 12, remote server can also control the operation of device 12 in order to, for example, conserve power. For example, if remote server 30 does not communicate data to device 12 or detects device 12 in a non-populated area, it may want to also shut down display 20 of device 12 or put device 12 into a sleep mode to conserve power.

The digital content distributed from remote server 30 can be sourced from advertisers, individuals, companies and the like. Typically, advertising content would be provided to remote server 30 by publishers. Publishing to device 12 can follow strategies similar to those employed in Internet publishing. The publisher can define target individuals and vehicles and a budget and remote server 30 can then distribute the content to a plurality of devices 12 according to the location and potential exposure.

Since users 14 and vehicles 25 are in fact moving billboards, users 14 and operators of vehicles 25 can profit from displaying content. For example, being rewarded for the time content is displayed and the location in which content is displayed. Rewards can incentivize users 14 and operators of vehicles 25 to be in locations of high population densities or locations in which desired target crowds (e.g. teens) are at (e.g. malls). They can earn points, cellular minutes or money, etc. based on what, where and for how long device 12 displayed the digital content.

Device 12 can also be used to display messages from individuals (e.g. show tweets or blogs), to display weather forecasts, possible delays on public transportation, rerouting of buses due to accident, unexpected closure of nearby metro stations, etc.

To further enhance the ability of an advertiser to target specific crowds, device 12 can also include a profile of user 14 or vehicle 25. Such a profile can include demographic information such as income, gender, age, as well as information such as interests, career, geographic location, movie and/or shopping preferences, travel destinations, etc. in the case of a user, or route traveled in the case of a vehicle 25 (especially a public transport vehicle) and preferences to specific advertisement subjects. Such information can be used by remote server 30 along with geo-location data to further enhance exposure estimations. Such information can be entered by user 14 or operator of vehicle 25 using the input interface of device 12.

Remote server 30 can also track device 12 through a predefined time period (e.g. a week) to better characterize the whereabouts of device 12. For example, if user 14 spends a predefined time of the week at a specific location (e.g. university campus), remote server can log such activity and use it for characterizing the exposure potential of device 12. Alternatively, if vehicle 25 is commuter car, the daily route can be logged and further analyzed for exposure potential along points along the route.

Remote server 30 can also communicate personal messages to user 14 or operator of vehicle 25 including useful information, account information (money or minutes earned) and entertainment information. Such personal communication can be used to create a dependency on device 12 ensuring that user 14 always carries device 12 and that operator of vehicle 25 maintains device 12 operational.

Although use of audio in publishing of content is less preferred in most areas due to the fact that it can be intrusive and annoying, device 12 can use audio as a means to get the attention of individuals. For instance, user 14 wearing device 12 is shopping in Tesco or other “brick-and-mortar” physical retailer. The GPS server 30, determining the location (aisle 3) of user 14 in front of the spaghetti section, can display a message suggesting the purchase of tomato sauce on sale in aisle 4.

Digital content displayed by device 12 can also include social and political messages, protest message (no smoking sign), sayings (I love NY . . . I love Michael . . . Peace . . . Love . . . I'm available), videos of sports events, YouTube content, picture(s) of loved ones, fashion accessories (an image of a diamond), important personal information (this is my mom, if you see me with anyone else please call the police, their favorite pet, what they did on holiday) and the like.

Device 12 can also be configured for feedback from an individual exposed to the content displayed thereupon. For example, an individual exposed to content can provide (directly to the device) a phone number or other personal information that can be used to reward the individual with prizes, coupons etc. Such feedback can be used by an advertiser to gauge the effectiveness of an advertising campaign, or a retailer to gauge the most cost effective use of space (merchandising and marketing). For instance, if user 14 wearing device 12 is in Harrods and stops for 10 minutes in front of the Prada display, 5 minutes in front of the Gucci display and 2 minutes in front of the D&G display, it can be deduced that the display of Prada drew more attention than others. If a similar pattern is reflected by other users it is logical to assume the D&G display needs to be altered in some way or replaced by another display.

It will be appreciated that although the remote digital content serving configuration described above is presently preferred, the present system can also be implemented using a local digital content serving configuration. In such a configuration, a computing device (personal computer, laptop, tablet or smartphone) can be used to store and display digital content on the device display or a display connected thereto. A software application executable by the device can be used to determine a geo-location of the device (e.g. from a built-in GPS unit); and select a type and/or a content of digital data from the digital data stored by the device according to a parameter relating to individuals that are in proximity to the system/user or to the vehicle/object on which the system is mounted.

Such a system can be an all-in-one system (single enclosure), or made of several interconnected component (CPU and storage, display, GPS unit) each in a separate enclosure.

An example of an all-in-one system that can be used by the present invention is a tablet such as an iPad. An iPad worn by a user (e.g. mounted on the back of a shirt/coat or backpack in a clear enclosure) can be configured with a dedicated software application (an app) and loaded with digital content files—e.g. video ads. When in use, the dedicated app executable by the iPad can determine the geo-location of the iPad from the GPS unit/cell signal, determine a parameter relating to individuals which might be in the vicinity of the iPad (in the manner described hereinabove) and load and play a specific local video file accordingly.

For example, a student carrying a backpack with an iPad mounted in a clear enclosure on the backside of the backpack can stroll through a university campus and the iPad can display a video advertisement of Nike shoes when geo-location data indicates that the student is in proximity to, or is inside of, an athletics stadium while a sporting event takes place.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed as new and desired to be protected by Letters Patent of the United States is:

1. A system for publishing digital content comprising:
(a) a device dynamically displaying a digital content element;
(b) a remote server being in communication with said device, said remote server being configured for:
(i) determining a geo-location of said device; and
(ii) communicating said digital content element to said device, wherein a type and/or a content of said digital content element is determined according to a parameter relating to a plurality of individuals being in proximity to said device.

2. The system of claim 1, wherein said parameter is selected from one or more of a number of said individuals, an age of said individuals, an activity of said individuals, interests of said individuals, preferences of said individuals and buying patterns of said individuals.

3. The system of claim 1, wherein said device includes a mobile device connected to a wearable display for displaying said digital content to said plurality of individuals being in proximity to said device, said mobile device including a mounting system directing said wearable display away from a wearer of said wearable display so a digital content element available on said wearable display is accessible by individual ones of said plurality of individuals.

4. The system of claim 3, wherein said mobile device is a cellular telephone.

5. The system of claim 1, wherein said device is carried by a user.

6. The system of claim 5, wherein said device is removeably mounted to a body of said user.

7. The system of claim 6, wherein said device is mounted on said body using a lanyard.

8. The system of claim 1, wherein said device is mounted on a vehicle.

9. The system of claim 1, wherein said remote server determines a geo-location of said device based on location data communicated from said device to said remote server.

10. The system of claim 9, wherein said location data is GPS, cellular Fi location data.

11. The system of claim 1, wherein said device includes an OLED or e-ink display.

12. The system of claim 1, wherein said digital data includes text, image and/or video content.

13. The system of claim 12, wherein said text, image and/or video content includes advertising content.

14. The system of claim 1 wherein said digital content element includes a machine-readable portion.

15. The system of claim 14 wherein said machine-readable portion includes a multidimensional barcode.

16. A system for publishing digital content comprising:
(a) a display displaying digital content;
(b) a storage device storing a digital content element;
(c) a device determining a geo-location of said display; and
(d) a software application for:
(i) using said geo-location to determine a parameter relating to individuals being in proximity to said display; and
(ii) determining digital content for display according to said parameter.

17. The system of claim 16, wherein said parameter includes one or more of a number of said individuals, an age of said individuals, an activity of said individuals, interests of said individuals, preferences of said individuals and buying patterns of said individuals.

18. The system of claim 16, wherein the system includes a mobile device connected to a wearable display for displaying said digital content.

19. The system of claim 16, wherein said display is mounted on a body of said user.

20. The system of claim 16, wherein said display is mounted on a vehicle.

21. A computer-implemented method of presenting digital content, comprising:
a) porting a portable electronic device including a display;
b) determining, using a computing system, a parameter relating to a plurality of individuals proximate to said display;
c) adding, using said computing system, digital content to said display responsive to said parameter established from a geo-location of said portable electronic device; and thereafter
d) presenting said digital content to said plurality of individuals using said display.

22. The method of claim 21 wherein said digital content includes a machine-readable portion, further comprising:
e) scanning, using a second portable electronic device operated by a particular one individual of said plurality of individuals, said machine-readable portion from said display.

23. The system of claim 22 wherein said machine-readable portion includes a multidimensional barcode.
